(19) United States
(12) Patent Application Publication
(10) Pub. No.: US 2011/0320053 A1
(43) Pub. Date: Dec. 29, 2011

(54) CONTROL SYSTEM HAVING USER-DEFINED CONNECTION CRITERIA

(76) Inventors: Chad Eric DOZIER, Washington, IL (US); Edward Maurer SCHROEDER, Germantown Hills, IL (US); Matthew Lee WAGNER, Dunlap, IL (US)

(21) Appl. No.: 13/084,264

(22) Filed: Apr. 11, 2011

Related U.S. Application Data
(60) Provisional application No. 61/358,557, filed on Jun. 25, 2010.

(51) Int. Cl. G06F 1/28

(52) U.S. Cl. 700/287

(57) ABSTRACT

A control system is provided for use with a plurality of generator sets. The control system may have a transmission network connected to a load and separately connectable to each of the plurality of generator sets. The control system may also have a selection module configured to receive from a user a selection of available parameters for use as criteria in determining connections of the plurality of generator sets with the transmission network, and a controller in communication with the plurality of generator sets and the selection module. The controller may be configured to detect a change in the load, and determine a desired change in a connection device of at least one of the plurality of generator sets with the transmission network based on the change in the load. The controller may be further configured to selectively affect the desired change based on the selection.

### RELATED APPLICATIONS

This application is based on and claims the benefit of priority from U.S. Provisional Application No. 61/358,557 by Chad E. DOZIER, Edward M. SCHROEDER, and Matthew L. WAGNER, filed Jun. 25, 2010, the contents of which are expressly incorporated herein by reference.

### TECHNICAL FIELD

The present disclosure relates to a control system and, more particularly, to a control system having user-defined connection criteria.

### BACKGROUND

A genset generally includes a generator driven by a prime mover, for example a combustion engine, to generate electric power. The engine provides the generator with a rotational input having a relatively constant torque and speed, and the generator accordingly produces an electric power output having relatively constant characteristics (frequency, voltage, phase, etc.). In some applications, a demand for electric power can exceed a power-producing capacity of a single genset and, thus, multiple gensets are connected in parallel to meet the demand in these situations. Preferably, the power demand remains relatively constant and all available gensets are continuously functional and each produces consistent electric power at optimum efficiency. In practice, however, the power demand fluctuates as loads are activated and deactivated, thereby requiring the number of gensets online at any given time to vary in order to efficiently provide the demand for consistent electric power.

The manner in which gensets are started and brought on-line, kept on-line, or moved off-line and shut down can affect performance of the system employing the gensets. For example, one genset may become load-ready faster than another genset, but also have a lower overall capacity or higher fuel consumption rate. In another example, one genset may have a lower operating cost, but produce higher levels of pollution and run at higher temperatures. Similar trade-offs may also exist between power quality, maintenance intervals, initial cost, warranty cost, lifetime expectancy, fuel type, etc. Depending on which genset at a particular facility is started first, shutdown first, or operated for a longer period of time, an overall system performance can be affected.

Historically, a command to startup or shutdown was given to all available gensets, and the first genset to be load-ready or shutdown-ready was allowed to execute the command. In this scenario, however, a system user had little control over the process and genset usage was prone to inconsistent performance.

An alternative approach to genset control is described in U.S. Pat. No. 6,664,653 issued to Edelman on Dec. 16, 2003 (“the '653 patent”). Specifically, the '653 patent discloses that a particular genset can be brought online or taken offline based on an total run time of each individual genset and the current or predicted demand for electric power. For example, a generator with a minimum run time is started first based on an actual or predicted increase in demand for electric power, and a generator with a maximum run time shuts down first based on an actual or predicted demand for less power. In this manner, each genset is operated for about the same amount of time and the life of the system employing the gensets may thereby be prolonged.

Although the system of the '653 patent may provide for extended system life in some situations, the benefit thereof may not be recognized by a user of the system or may be limited. In particular, if the user is more interested in operating cost, power quality, supply interruption, or other similar characteristics, rather than extended system life, the system of the '653 patent may be viewed as performing poorly, even though system life may have been extended.

The disclosed control system is directed to overcoming one or more of the problems set forth above and/or other problems of the prior art.

### SUMMARY

One aspect of the present disclosure is directed to a control system for use with a plurality of generator sets. The control system may include a transmission network connected to a load and separately connectable to each of the plurality of generator sets. The control system may also include a selection module configured to receive from a user a selection of available parameters for use as criteria in determining connections of the plurality of generator sets with the transmission network, and a controller in communication with the plurality of generator sets and the selection module. The controller may be configured to detect a change in the load, and determine a desired change in a connection device of at least one of the plurality of generator sets with the transmission network based on the change in the load. The controller may be further configured to selectively affect the desired change based on the selection.

A second aspect of the present disclosure is directed to a method of operating a plurality of generator sets connected in parallel to an external load. The method may include receiving from a user a selection of available parameters for use as criteria in determining connections of the plurality of generator sets to the external load. The method may also include detecting a change in the external load, and determining a desired change in a connection device of at least one of the plurality of generator sets based on the change in the external load. The method may further include affecting the desired change based on the selection.

### BRIEF DESCRIPTION OF THE DRAWINGS

FIG. 1 is a schematic illustration of an exemplary disclosed power system; and

FIG. 2 is flowchart depicting an exemplary disclosed method of operating the power system of FIG. 1.

### DETAILED DESCRIPTION

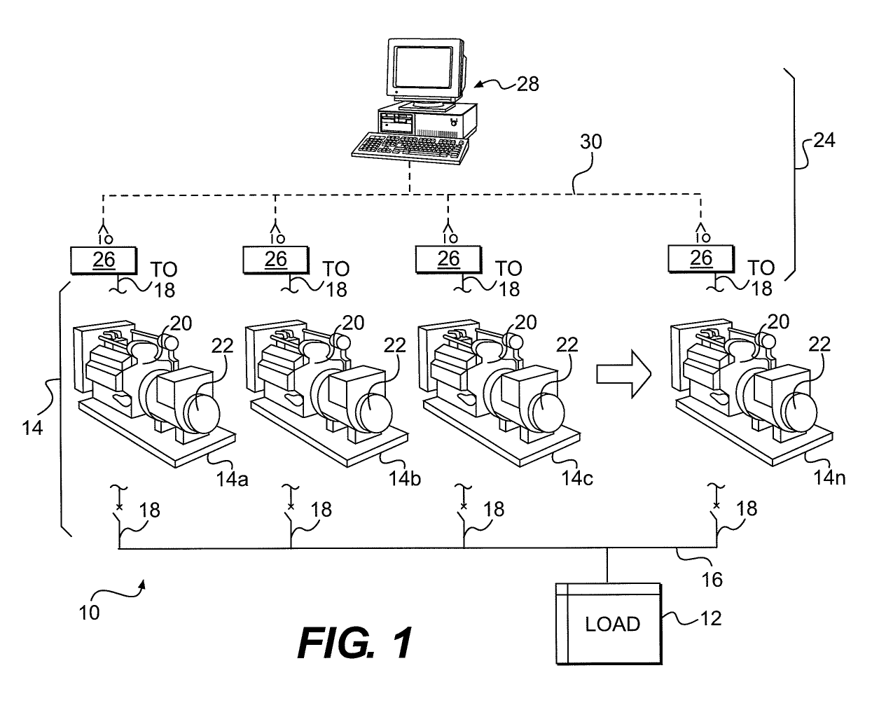

FIG. 1 illustrates an exemplary power system 10 consistent with certain disclosed embodiments. Power system 10 may be configured to provide primary, supplemental, and/or backup power to an external load 12. In one exemplary embodiment, backup power may include an immediate supply of reserve power provided to external load 12 when power from a utility power grid (not shown) is interrupted, insufficient, or otherwise unsuitable. As shown in FIG. 1, power system 10 may comprise a plurality of generator sets (gensets) 14, including gensets 14a, 14b, 14c, and 14n. Gensets 14 may be connected in parallel to external load 12 by way of a power transmission network 16 and a plurality of connection devices 18.

External load 12 may include any type of power consuming system or device configured to receive electric power supplied by gensets 14 and to utilize the electric power to perform some type of task. External load 12 may include, for example, lights, motors, heating elements, electronic circuitry, refrigeration devices, air conditioning units, computer servers, etc. In one exemplary embodiment, external load 12 may include one or more systems and/or devices that utilize uninterrupted electrical power to perform one or more critical and/or sensitive tasks. For example, electrical loads 12 that utilize uninterrupted power may include those found in hospitals, airports, computer servers, telecommunication installations, and/or industrial applications. When one or more of the systems or devices of external load 12 are switched on or off, a magnitude of external load 12 may change and require a corresponding a change (i.e., increase or decrease) in the supply of electric power from gensets 14.

Transmission network 16 may include any system components useful for distributing electric power produced by gensets 14 to external load 12. For example, transmission network 16 may include a system comprised of power stations, transmission lines, power relays, and other suitable devices for distributing electric power across a grid. In one embodiment, portions of transmission network 16 may be buried underground and/or run overhead via transmission towers.

Connection devices 18 may embody any type of device that is capable of coupling together one or more of gensets 14 with external load 12. For example, connection device 18 may include various switches, junction boxes, circuit interrupters, breakers, fuses, or any other components that may be suitable for electrically interconnecting one or more systems. Connection device 18 may also or alternatively include a voltage transformer and/or a power synchronizer configured to reduce, increase, or otherwise condition the power provided by gensets 14 to a suitable level for use by conventional consumer devices.

Gensets 14 may each include components that operate to generate electricity. In one embodiment, each genset 14 may comprise a prime mover 20 coupled to mechanically rotate a generator 22 that provides electric power to external load 12. For the purposes of this disclosure, prime mover 20 is depicted and described as a heat engine, for example, a combustion engine that combusts a mixture of fuel and air to produce the mechanical rotation. One skilled in the art will recognize that prime mover 20 may be any type of combustion engine such as, for example, a diesel engine, a gasoline engine, or a gaseous fuel-powered engine.

Generator 22 may be, for example, an AC induction generator, a permanent-magnet generator, an AC synchronous generator, or a switched-reluctance generator that is mechanically driven by prime mover 20 to produce electric power. In one embodiment, generator 22 may include multiple pairings of poles (not shown), each pairing having three phases arranged on a circumference of a stator (not shown) to produce an alternating current. Electric power produced by generator 22 may be directed for offboard purposes to external load 12 via transmission network 16.

It is contemplated that one or more of gensets 14 may be substantially different from one or more others of gensets 14 within the same power system 10. That is, one or more of gensets 14 may have a greater or lesser electric power output capacity, fuel consumption rate, emission production rate, operating cost, operating temperature, noise level, efficiency, etc., than another of gensets 14. Similarly, one or more gensets 14 may have a different maintenance interval, run time, fuel type, location, etc. Each of these parameters may have values specific to individual gensets 14 and can have an effect on the overall performance of power system 10. Accordingly, gensets 14 may each be operated and controlled differently, depending on which of the parameters are selected as control criteria by a user of power system 10.

To help regulate operation of gensets 14 and their connection to external load 12, power system 10 may be provided with a control system 24. Control system 24 may include at least one controller 26 operatively connected to each genset 14 and to transmission network 16, and a selection module 28 in communication with controller 26. In an exemplary embodiment, one controller 26 may be paired with and dedicated to controlling only one of gensets 14 and may communicate with other controllers 26 of other gensets 14 via at least one communication cable 30. It is contemplated that each controller 26 could control more than one of gensets 14, if desired, and that any number of communication cables 30 may be utilized. Selection module 28 may be configured to receive from the user of power system 10 a selection and prioritization of available parameters for use as criteria in determining connections of gensets 14 with transmission network 16, and to communicate signals indicative of the user's selection to controller 26 via communication cable 30. Selection module 28 may embody, for example, an onboard interface device such as a computer console that is hard wired to controller 26, a portable device such as a laptop computer or

PDA that is selectively connected to controller 26, or a remote device that is wirelessly connected to controller 26.

Each of gensets 14 may be designed to accommodate a range of electrical loading. When operating within this range, performance of genset 14 may be substantially consistent and efficient, and component life of genset 14 may be substantially unaffected. When a load on any one of gensets 14 exceeds or falls below the desired operating range, performance of that genset 14 may become inconsistent, efficiency may worsen, and component life may be reduced. Accordingly, communication cable 30 may extend between all of gensets 14 and be configured to transmit signals from any one of gensets 14 to all other gensets 14 of the same power system 10 regarding operation of the transmitting genset 14. These signals may be indicative of, for example, a load of the transmitting genset 14 exceeding the desired operating range, a load of the transmitting genset 14 falling below the desired operating range, an ongoing operational status change of the transmitting genset 14 (i.e., when any one of gensets 14 is ramping up or down in power and connecting or disconnecting to supply or stop supplying power to external load 12), normal or abnormal status associated with electrical output of gensets 14 (i.e., associated with a frequency, voltage, and/or phase match of a particular genset 14), and/or other parameters known in the art. Based on these signals and on the user-selected criteria, controllers 26 may selectively startup, shutdown, or block operational changes of other gensets 14, and connect or disconnect any of gensets 14 from load 12 via connection devices 18.

Each of controllers 26 may be configured to detect signals on cable 30, to regulate operation of its paired genset 14 in response to the detected signals, and to generate signals on cable 30 directed to other gensets 14 within the same power system 10. Each controller 26 may embody a single or multiple microprocessors, field programmable gate arrays (FPGAs), digital signal processors (DSPs), etc. that include a means for controlling an operation of its paired genset 14 in response to various input. Numerous commercially available microprocessors can be configured to perform the functions of controller 26. Various other known circuits may be associated with controller 26, including power monitoring circuitry, power supply circuitry, signal-conditioning circuitry, actuator driver circuitry (i.e., circuitry powering solenoids, motors, or piezo actuators), communication circuitry, and other appropriate circuitry.

According to one embodiment, each controller 26 may be configured to affect a change of the operational status of its paired genset 14 based on signals detected on cable 30. For example, in response to detection of an overload signal on cable 30, one or more of controllers 26 associated with offline gensets 14 may trigger their paired gensets 14 to power up in preparation for supplying power to external load 12 (i.e., each controller 26 may prepare its paired genset 14 to come online). Similarly, in response to detection of an excess capacity signal on cable 30, each controller 26 of an online genset 14 may trigger its paired genset 14 to power down in preparation for stopping its supply of power to external load 12 (i.e., each controller 26 may prepare its paired genset 14 to go offline). Further, in response to detection of a transitioning signal on cable 30 (i.e., a signal indicative of one of gensets 14 responding to an overload or excess capacity signal by attempting to go online or move offline), each controller 26 of all other gensets 14 within power system 10 may inhibit its paired genset 14 from ramping power up, ramping power down, going online, or going offline. Once a genset 14 has ramped power up or down and is producing electrical power at a desired output level (i.e., once a genset is load-ready), and if no other gensets 14 are currently trying to go online or move offline, the genset's paired controller 26 may automatically activate connection device 18 to either close and connect or open and disconnect the respective genset 14 from external load 12.

In one embodiment, a delay may be associated with the operational status change of gensets 14. That is, after an overload and/or excess signal on cable 30 is detected, each controller 26 may be configured to delay a set time period before triggering the operational status change (i.e., before power ramp up, power ramp down, connecting, or disconnect its paired genset 14).

The set time period may be different for each genset 14. In one example, each genset 14 may be assigned a priority number, and the set time period may be a function of that priority number. For instance, genset 14a may have a set time period f(a), genset 14b may have a set time period f(b), genset 14c may have a set time period f(c), and genset 14n may have a set time period f(n). In this manner, even though all of controllers 26 may simultaneously detect an overload and/or excess capacity signal on cable 30, only one of controllers 26 may attempt to change an operational status of its paired genset 14 at a given time due to the different time delays.

The time delays associated with operational status changes of gensets 14 may be related to the user-selected criteria described above, and may be changed at any time by the user. That is, because some gensets 14 within power system 10 may have operating parameters that are different from operating parameters of other gensets 14 within power system 10, the time delay can be linked to these parameters such that particular gensets 14 have shorter or longer set time periods for delay than other gensets 14. These shorter or longer set time periods may cause gensets 14 to startup and go online or shutdown and go offline at different times and in a particular order such that a desired overall performance of power system 10 is achieved. In one example, operating cost may be of primary concern to a user, and gensets 14 may be controlled in such a manner as to minimize operating cost. In another example, however, exhaust emissions, noise levels, maintenance intervals, genset longevity, etc., may be of primary concern to the user, and gensets 14 may be controlled in a different manner to achieve specific goals. As will be described in more detail below, the user-selected criteria may help to define and affect the user's ultimate goal for power system 10.

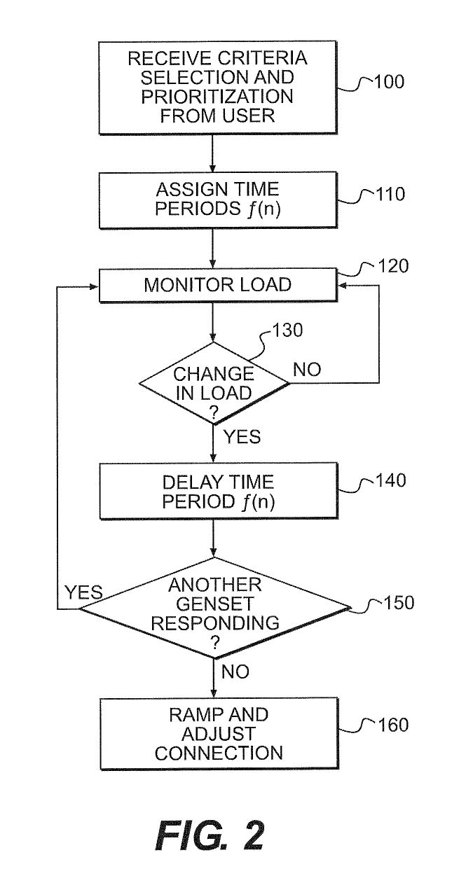

FIG. 2 illustrates an exemplary operation of power system 10. FIG. 2 will be discussed in more detail in the following section to further illustrate the disclosed concepts.

### INDUSTRIAL APPLICABILITY

The disclosed power system may provide a variable supply of electric power to an external load in a desired manner. In particular, the disclosed power system may selectively bring gensets online and move them offline in response to a change in load on any one genset and in an order that may be based on user-selected criteria. By adjusting operational status of the gensets based on a change in load of any one genset within the same power system, each genset may be operated within a desired range that results in high efficiency. By bringing gensets online and moving them offline in a particular order that is based on user-selected criteria, customized goals for the power system may be obtained. FIG. 2 illustrates a flowchart depicting an exemplary method for operating power system 10. FIG. 2 will now be discussed in detail.

At any time during operation of power system 10, a user may make selections via selection module 28 of parameters to be used in determining which of gensets 14 should startup and connect to load 12 or shutdown and disconnect from load 12 in response to a detected change in load 12. In one particular example, a user may select from a list of available parameters, fuel type, maintenance interval, and output capacity as parameters that are important to the user and should be used as criteria in deciding startup and shutdown orders of gensets 14. The user may then assign priorities to the selected parameters. For example, the user may determine that output capacity is most important, followed by fuel type, and then maintenance interval. Selection module 28 may receive the user's selection and prioritization, and direct corresponding signals to controllers 26 that are indicative of the connection criteria (Step 100).

Each controller 26 may assign a specific time period f(n) to its paired genset 14 based on the user-defined criteria (Step 110). For example, those gensets 14 having the selected output capacity, that run on the selected fuel, and/or that have been maintained within the selected interval, may be assigned shorter time periods than the remaining gensets 14 of power system 10. Similarly, of the selected subset of gensets 14, those gensets 14 having the selected output capacity may be assigned the shortest time period, while the gensets 14 having the selected maintenance interval may be assigned the longest time period of the subset.

During operation of power system 10, each controller 26 may continuously monitor discrete signals on cable 30 that are indicative of load 12 (Step 120). During this monitoring, each controller 26 may detect when an overload or excess capacity signal is generated on cable 30 by another of gensets 14 and responsively determine that a magnitude of load 12 has changed (Step 130). If an overload or excess capacity signal is not detected, control may return to step 120. However, if, for example, an overload signal is detected on cable 30, it can be concluded that load 12 has increased and additional gensets 14 are desired to come online and start supplying the electric power demand of load 12 (Step 130: Yes). In this situation, each controller 26 of the offline gensets 14 may first delay the set time period f(n) associated with its paired genset 14 (Step 140), and then check to see if another genset is already responding to the overload signal on cable 30 (Step 150). If a signal on cable 30 indicates that another genset 14 is already responding to the load change, control may return to step 120 without further action. However, if at step 150 controller 30 does not detect a responding signal on cable 30 from another genset 14 (Step 150: NO), controller 26 may change the operational status of its paired genset 14, ramp up power output thereof, and close connection device 18 to connect the power output to external load 12 (Step 160).

In another example, if at step 130 an excess capacity signal is detected on cable 30 (Step 130: YES), controller 26 may delay the set time period associated with its paired genset 14 (Step 140), before taking further action. It is contemplated that the set time period for responding to an overload signal may be different than the set time period for responding to an excess capacity signal, if desired. After the set time period associated with an excess capacity signal has expired, controller 26 may then check to see if another genset 14 is already responding to the excess capacity signal (Step 150). If at step 150 controller 26 does not detect a responding signal on cable 30 from another genset 14, controller 26 may change the operational status of its paired genset 14, ramp down power output thereof, and open connection device 18 to disconnect the power output from external load 12(Step 160).

It will be apparent to those skilled in the art that various modifications and variations can be made in the disclosed control system without departing from the scope of the disclosure. Other embodiments of the disclosed control system will be apparent to those skilled in the art from consideration of the specification and practice of the control system disclosed herein. It is intended that the specification and examples be considered as exemplary only, with a true scope of the disclosure being indicated by the following claims.

What is claimed is:

1. A control system for use with a plurality of generator sets, comprising:
a transmission network connected to a load and separately connectable to each of the plurality of generator sets;
a selection module configured to receive from a user a selection of available parameters for use as criteria in determining connections of the plurality of generator sets with the transmission network; and
a controller in communication with the plurality of generator sets and the selection module, the controller being configured to:
detect a change in the load;
determine a desired change in a connection device of at least one of the plurality of generator sets with the transmission network based on the change in the load; and
selectively affect the desired change based on the selection.

2. The control system of claim 1, wherein:
the selection module is further configured to receive from the user a prioritization of the selected parameters; and
the controller is further configured to selectively affect the desired change based also on the prioritization.

3. The control system of claim 1, wherein the controller is configured to selectively affect the desired change by ramping up power of the at least one of the plurality of generator sets.

4. The control system of claim 3, further including a plurality of connection devices associated with the plurality of generator sets, wherein the controller is configured to selectively affect the desired change by closing an associated one of the plurality of connection devices after the at least one of the plurality of generator sets has ramped up in power and is load-ready.

5. The control system of claim 1, wherein the parameters have values specific to individual generator sets of the plurality of generator sets.

6. The control system of claim 5, wherein the known parameters are associated with at least one of emissions, efficiency, fuel type, fuel consumption, location, maintenance interval, noise, operating cost, operating temperature, output capacity, and run time.

7. The control system of claim 1, wherein the controller is further configured to selectively affect desired changes in connection devices of multiple generator sets of the plurality of generator sets based on the change in the load and in a particular order based on the selection.

8. The control system of claim 1, wherein the controller is configured to monitor operation of an online generator set of the plurality of generator sets to determine the change in the load.

9. A method of operating a plurality of generator sets connected in parallel to an external load, the method comprising:
receiving from a user a selection of available parameters for use as criteria in determining connections of the plurality of generator sets to the external load;
detecting a change in the external load;
determining a desired change in a connection device of at least one of the plurality of generator sets based on the change in the external load; and
affecting the desired change based on the selection.

10. The method of claim 9, further including receiving from a user a prioritization of the selected parameters, wherein the desired change is affected based also on the prioritization.

11. The method of claim 9, wherein affecting the desired change includes ramping up power of the at least one of the plurality of generator sets.

12. The method of claim 11, wherein affecting the desired change further includes closing a connection device associated with the at least one of the plurality of generator sets after the at least one of the plurality of generator sets has ramped up in power and is load-ready.

13. The method of claim 9, wherein the parameters have values specific to individual generator sets of the plurality of generator sets.

14. The method of claim 13, wherein the known parameters are associated with at least one of emissions, efficiency, fuel type, fuel consumption, location, maintenance interval, noise, operating cost, operating temperature, output capacity, and run time

15. The method of claim 9, further including affecting changes in connection devices of multiple of the plurality of generator sets that correspond with the change in the external load and in a particular order based on the selection.

16. The method of claim 9, wherein detecting a change in the external load includes comparing an output of an online generator set of the plurality of generator sets to desired operation parameters.

17. A power system, comprising:
an external load;
a transmission network connected to the external load;
a first generator set;
a first connection device configured to selectively connect an output of the first generator set to the transmission network;
a second generator set;
a second connection device configured to selectively connect an output of the second generator set to the transmission network;
a selection module configured to receive from a user a selection of available parameters for use as criteria in determining connections of the first and second generator sets with the transmission network, and a prioritization of the selection; and
a controller in communication with the first and second generator sets, the first and second connection devices, and the selection module, the controller being configured to:
detect a change in the external load;
determine a desired change in a connection device of at least one of the first and second generator sets based on the change in the load; and
selectively affect the desired change based on the selection and the prioritization.

18. The power system of claim 17, wherein the controller is configured to selectively affect the desired change by:
ramping up power of the at least one of the first and second generator sets; and
closing a corresponding one of the first and second connection devices after the at least one of the first and second generator sets has ramped up in power and is load-ready.

19. The power system of claim 17, wherein the parameters include at least one of emissions, efficiency, fuel type, fuel consumption, location, maintenance interval, noise, operating cost, operating temperature, output capacity, and run time that have values specific to the first and second generator sets.

20. The power system of claim 17, wherein the controller is further configured to selectively affect changes in the first and second connection devices corresponding to the change in load and in a particular order based on the selection and the prioritization.
